(19) United States
(12) Patent Application Publication
(10) Pub. No.: US 2016/0308376 A1
(43) Pub. Date: Oct. 20, 2016

(54) ENERGY STORAGE SYSTEM

(71) Applicant: Robert Bosch GmbH, Stuttgart (DE)

(72) Inventor: Constanze Sorhage, Leinfelden-Echterdingen (DE)

(21) Appl. No.: 15/098,555

(22) Filed: Apr. 14, 2016

(30) Foreign Application Priority Data
Apr. 16, 2015 (DE) 102015206871.4

(51) Int. Cl. H02J 7/00

(52) U.S. Cl. CPC H02J 7/0029; H02J 7/0057; H02J 2007/0037

(57) ABSTRACT

A system includes a rechargeable electrical energy store having a predetermined nominal capacity and a predetermined maximum capacity, the maximum capacity being higher than the nominal capacity, and a charging unit for controlling a charging process of the energy store. The charging unit is configured for the purpose of charging the energy store until the amount of energy stored in it equals the nominal capacity, and then to determine an end of charging.

### CROSS REFERENCE

The present application claims the benefit under 35 U.S.C. §119 of German Patent Application No. 102015206871.4 filed on Apr. 16, 2015, which is expressly incorporated herein by reference in its entirety.

### FIELD

The present invention relates to an energy storage system. In particular, the present invention relates to a system which includes a rechargeable electrical energy store and a charging unit for the energy store.

### BACKGROUND INFORMATION

An electric hand tool such as a cordless screwdriver, for example, a flashlight or an electric edge trimmer, obtains the electrical energy required for its operation from a rechargeable electrical energy store. The energy store may be in the form of a rechargeable battery pack, for example, and may be removed from the device when an electrical energy store is exhausted to make uninterrupted work possible. The discharged electrical energy store may then be recharged at a charging unit. The charging may also take place inside the electric hand tool.

It is desirable to be able to recharge the electrical energy store as rapidly as possible so that it may be connected to an electrical device for continued use. In particular, when multiple electrical devices may be used with one or multiple identical electrical energy stores, it may be of critical importance to be able to recharge the electrical energy stores quickly. In addition to the obvious advantages of the improved utilization and ease of operation, this rapid recharge capability also avoids that a larger number of electrical energy stores have to wait at a charging unit for a recharge.

German Patent No. DE 38 34 003 A1 describes a method for the recharging of batteries and to a charging unit for carrying out the method.

German Patent No. DE 102 54 226 A1 describes a battery pack which is used as a power supply unit for a portable device.

An object of the present invention is to provide an improved technology for recharging the electrical energy store. The present invention may accomplish this object.

### SUMMARY

A system includes a rechargeable electrical energy store having a predetermined nominal capacity and a predetermined maximum capacity, the maximum capacity being greater than the nominal capacity, and a charging unit for controlling the charging process of the energy store. The charging unit is configured to recharge the energy store until the amount of energy stored in it equals the nominal capacity, and then to determine an end of charging.

The energy store is recharged with the aid of the charging unit only up to a fraction of its maximum capacity, namely up to its nominal capacity. The nominal capacity makes it possible for the user to evaluate the performance of the electrical energy store and to compare the electrical energy store with other energy stores. By dispensing with the charging of the electrical energy store up to the maximum capacity, a significant portion of the charging time of the energy store may be saved. For example, the nominal capacity may be selected in such a way that with a conventional charging process, the increase in the amount of electrical energy stored is linear over time until the nominal capacity is reached. If the electrical energy store were to continue to be charged until the amount of electrical energy stored in it equals its maximum capacity, the relationship between stored energy and recharging time would not be linear, but in fact would be generally logarithmic. As a result of the restriction of the charging to the nominal capacity, the charging time may be shortened by up to several 10%.

The charging unit is preferably configured to end the charging process of the energy store when the end of charging is reached. Regardless, the end of charging may be signaled externally, for example by a light or acoustical signal. The termination of the charging process at the end of charging ensures that the electrical energy store cannot provide more electrical energy than its nominal capacity. The comparability of the performance of the electrical energy store may therefore be ensured.

In one specific embodiment, the charging unit is configured to charge the energy store with a constant current until its voltage reaches a predetermined threshold value. This charging process is also called a constant current charging process. The predetermined threshold value is usually determined by the type of the electrical energy store and usually equals a defined maximum voltage that may be reached during charging up to the maximum capacity. The fixed portion may be 80% to 90%.

The predetermined current may be determined on the basis of the maximum capacity of the energy store. The end of charging may be determined immediately after the predetermined threshold value is reached by the voltage of the energy store.

For this purpose, preferably an energy store is used in which the voltage applied to it is usable as a measure for the amount of energy stored in it. Energy stores of this type may include nickel-metal hydride or lithium-ion storage batteries, for example. Other battery technologies may also be used.

In one further specific embodiment, the charging unit is configured to subsequently continue to charge the energy store, i.e., after the charging with the aid of a constant current, at a predetermined voltage until the current flowing through the energy store has dropped to a predetermined level. The predetermined level may also be specified by the type of the electrical energy store. This charging strategy is also called constant voltage. In combination with a chronologically prior constant current process, as described above, the result is what is termed a constant current, constant voltage process (CCCV). Depending on the technology used, care should be taken that the constant voltage process is carried out only as long as necessary to reach the nominal capacity. In a complete CCCV process until the maximum capacity is achieved, typically a constant current charge is applied for approximately 50% to 70% of the charging time before switching over to the constant voltage process. It is suggested that the nominal capacity is be selected in such a way that in a usual CCCV process it is either at the changeover point in time between the constant current and constant voltage process or shortly thereafter. The constant voltage process is preferably used for not more than approximately 5% to 10% of the total charging time.

When the constant voltage process is used, it is preferred that the current flowing through the energy store is usable as a measure of the amount of energy stored in it. In usual electrical energy stores, such as the nickel-metal hydride or lithium-ion type, for example, this relationship exists. The lower the charging current during the constant voltage process, the closer the amount of energy stored in the electrical energy store is to the maximum capacity.

It is particularly preferred that the maximum capacity is at least 10% greater than the nominal capacity. Depending on the type and maximum capacity of the electrical energy store, 90% of the maximum capacity may be achieved, for example, after approximately 50% to 70% of the charging time if the CCCV process is used. By—largely—dispensing with the constant voltage process, a substantial saving of charging time may therefore be achieved with relatively minor reductions of the nominal capacity compared to the maximum capacity.

In one further preferred specific embodiment, the charging unit is integrated into the electrical energy store as a separately manageable unit. It may therefore be ensured that the electrical energy store is not charged beyond the nominal capacity, so that the manageability and comparability of the electrical energy store may be ensured.

### BRIEF DESCRIPTION OF THE DRAWINGS

The present invention is explained in greater detail below with reference to the figures.

FIG. 1 shows a system including an electrical energy store and a charging unit.

FIG. 2 shows a system according to FIG. 1 in an additional specific embodiment.

FIG. 3 shows a charging diagram of an electrical energy store during fast charging.

FIG. 4 shows a charging diagram of an electrical energy store during normal charging.

### DETAILED DESCRIPTION OF EXAMPLE EMBODIMENTS

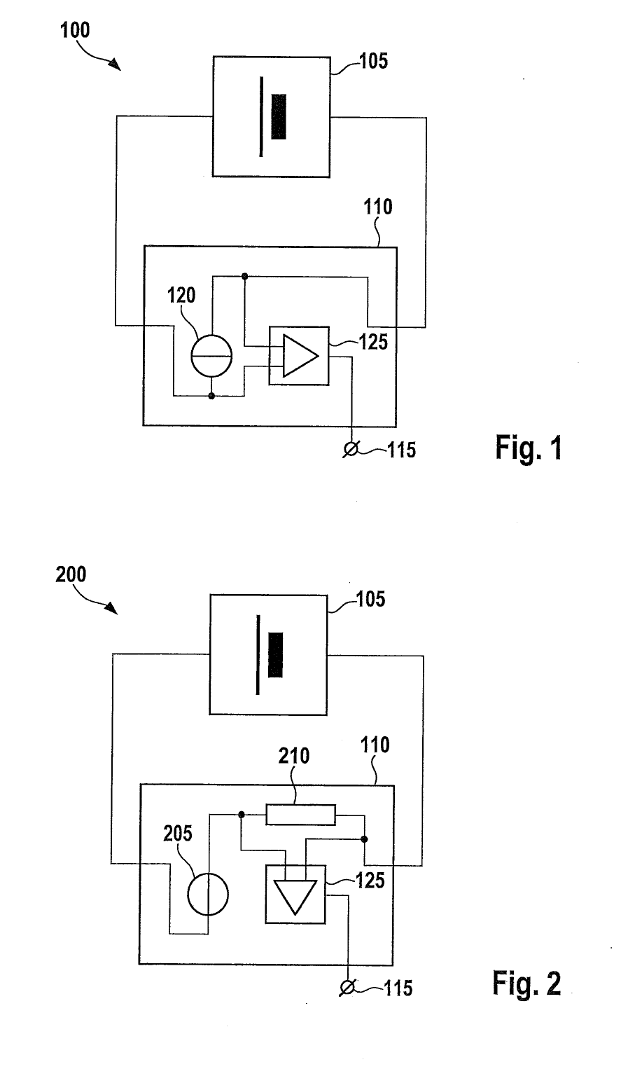

FIG. 1 shows a system 100 including an electrical energy store 105 and a charging unit 110. Energy store 105 may be separable from charging unit 110 or integrated into it. Energy store 105 preferably includes multiple identical cells of a conventional storage battery technology, such as lithium-ion or metal-hydride technology, for example. Energy stores 105 of this type are available under the name, “Akkupack.” The internal configuration of energy store 105 is not further discussed here.

Charging unit 110 may generally be connected to an external energy source which is not illustrated here. This energy source may be, for example, a power network or an electrical system of a motor vehicle. Charging unit 110 is configured to charge electrical energy store 105 up to a nominal capacity which is significantly less than a maximum capacity of energy store 105. The maximum capacity thereby indicates how much electrical energy may be made available in energy store 105 without substantially damaging the energy store 105. The nominal capacity is only a portion of the maximum capacity, for example a maximum of 90%, and more preferably a maximum of 80% of the maximum capacity.

For this purpose, charging unit 110 may be configured to carry out one of several charging processes or also multiple different charging processes one after another. It thereby determines whether the electrical energy available in energy store 105 equals or has reached the nominal capacity and thereby detects the end of charging. When the end of charging is reached, charging unit 110 may output a signal with the aid of an interface 115 that indicates the end of charging. The signal may be visual or acoustical, for example. Additionally or alternatively, the further charging of energy store 105 may be terminated when the end of charging is reached. For this purpose, energy store 105 may in particular be electrically disconnected from additional elements of charging unit 110 at at least one terminal.

In the illustrated specific embodiment, charging unit 110 is configured to carry out a constant current (CC) process. For this purpose, charging unit 110 includes a power source 120 to provide a constant current. The magnitude of the constant current may in particular be a function of the maximum capacity of energy store 105. For example, the constant current may be the capacity of energy store 105 divided by the time, so that an energy store 105 with a maximum capacity of 4 Ah may be charged with a constant current of 4 A. Other constant currents are also possible.

Charging unit 110 further includes a comparator 125, which is configured to compare a voltage applied to the terminals of electrical energy store 105 with a predetermined value. The higher the voltage of energy store 105, the greater the amount of electrical energy stored in it. When the predetermined value is reached, the amount of energy stored in energy store 105 is as great as its nominal capacity. The predetermined value is in the form of a threshold value and is associated with energy store 105. In particular, the value may include a maximum open-circuit voltage of energy store 105. The end of charging is determined by the voltage of energy store 105 reaching the predetermined value, whereupon, as described above, a signal is output via interface 115 and/or the further charging of energy store 105 may be stopped. The signal may be addressed to an operator or to a processing unit.

FIG. 2 shows a system 100 according to FIG. 1 in a further specific embodiment. In this case, charging unit 110 is configured to carry out a constant voltage (CV) process instead of the constant current process described above with reference to FIG. 1. For this purpose, charging unit 110 includes a voltage source 205 which is a constant voltage source. The voltage of voltage source 205 usually corresponds to the voltage reached in energy store 105 when the latter is charged to its maximum capacity. For the determination of the end of charging, the current flowing through energy store 105 is monitored, for example on the basis of the voltage drop at a series resistance (shunt) 210 which is looped into a feeder line of energy store 105. This voltage is compared with the aid of comparator 125 with a predetermined value. The greater the amount of energy stored in energy store 105, the smaller the amount of current flowing through it while it is connected with constant voltage source 205. Comparator 125 thereby determines the end of charging as soon as the voltage monitored by it is less than or equal to the predetermined value. When the end of charging is reached, one of the actions described above with reference to FIG. 1 may be carried out again.

Charging unit 110 may also be configured to carry out both charging processes illustrated in FIGS. 1 and 2. Preferably, the constant current process illustrated in FIG. 1 is initially carried out, and then optionally, over a short period of time, the constant voltage process illustrated in FIG. 2. Regardless of the charging strategy used, the goal of charging unit 110 is to not continue to charge electrical energy store 105 beyond the point at which the amount of energy stored in it corresponds to its nominal capacity.

In one further specific embodiment, energy store 105 may continue to be charged after it reaches its nominal capacity, maximally to the point at which it reaches its maximum capacity.

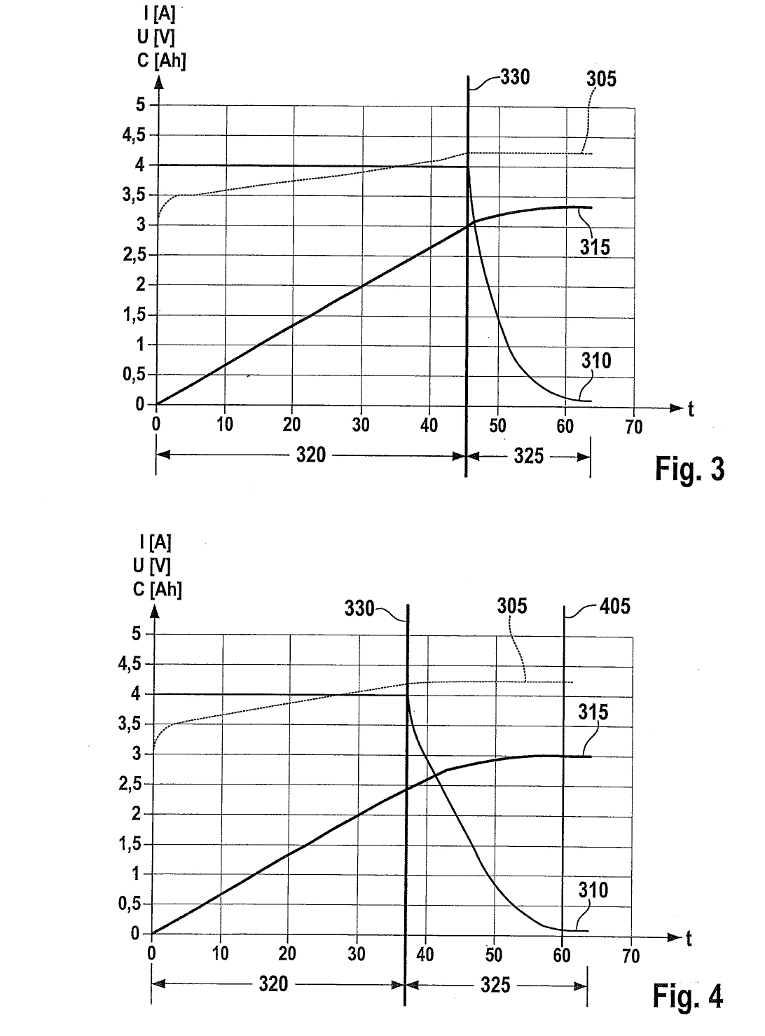

FIG. 3 shows, by way of example, a charging diagram of an electrical energy store 105 during a fast charge. In the diagram, the time in minutes is plotted in the horizontal direction; a current, a voltage and a capacity are plotted in the vertical direction. A first curve 305 shows a voltage at energy store 105, a second curve 310 shows a current through energy store 105, and a third curve 315 shows a capacity of energy store 105 or the amount of the energy present in energy store 105. By way of example, FIG. 3 relates to an energy store 105 having a maximum capacity of 3.3 Ah and a maximum voltage of 4.2 V with a fully charged energy store 105. In a first phase 320, energy store 105 is charged with the aid of the constant current process (see FIG. 1) and then, in a second phase 325, with the aid of the constant voltage process (see FIG. 2). A switchover point in time 330 lies between the two phases 320 and 325.

Capacity 315 of energy store 105 increases in a practically linear fashion during first phase 320. During second phase 325, on the other hand, the increase becomes slower and slower. With regard to the time spent, the charging during first phase 320 is more effective than the charging during second phase 325. First phase 320 is ended when voltage 305 has reached a predetermined value, in the illustrated example 4.19 V. At the end of second phase 325, the voltage amounts to 4.2 V. The amount of energy present in energy store 105 at the switchover point in time 330 is approximately 3.0 Ah. Starting from a completely discharged energy store 105, this value is reached after 45 minutes of charging time. The maximum capacity of 3.3 Ah is reached approximately 18 minutes later.

It is suggested to select the end of charging at point in time 330 or shortly thereafter. The nominal capacity of energy store 105 in this example is therefore approximately 3.0 Ah. In one further specific embodiment, the illustrated CCCV process may also be carried out, as long as the increase in capacity 315 is linear over time. In this example, the linearity ends approximately 3 minutes after switchover point in time 330.

For purposes of comparison, FIG. 4 shows a charging diagram of an electrical energy store 105 during normal charging. In this case, a maximum capacity of 3.0 Ah and a charging current of 4 A is assumed. Again, energy store 105 is charged in a first phase 320 with the aid of the constant current process and during a subsequent second phase 325 with the aid of the constant voltage process. At a point in time 405, a final disconnect takes place, and energy store 105 is not charged further to prevent damage caused by overcharging.

What is claimed is:

1. A system, comprising:
a rechargeable electrical energy store having a predetermined nominal capacity and a predetermined maximum capacity, the maximum capacity being higher than the nominal capacity;
a charging unit to control a charging process of the energy store, the charging unit being configured to charge the energy store until an amount of energy stored in the energy store corresponds to the nominal capacity, and then to determine an end of charging.

2. The system as recited in claim 1, wherein the charging unit is configured to end the charging of the energy store when the end of charging is reached.

3. The system as recited in claim 1, wherein the charging unit is configured to charge the energy store with a constant current until a voltage of the energy store reaches a predetermined threshold value.

4. The system as recited in claim 2, wherein the voltage applied to the energy store is usable as a measure for the amount of energy stored in the energy store.

5. The system as recited in one of claim 3, wherein the charging unit is configured to subsequently continue to charge the energy store to a predetermined voltage until a current flowing through the energy store has dropped to a predetermined value.

6. The system as recited in claim 5, wherein the voltage equals the threshold value.

7. The system as recited in claim 5, wherein the current flowing through the energy store is usable as a measure for the amount of energy stored in the energy store.

8. The system as recited in claim 1, wherein the maximum capacity is at least 10% higher than the nominal capacity.

9. The system as recited in claim 1, wherein the charging unit is integrated into the electrical energy store as a separately manageable unit.
